(19) United States
(12) Patent Application Publication
(10) Pub. No.: US 2006/0176821 A1
(43) Pub. Date: Aug. 10, 2006

(54) Network bandwidth utilization verification method and apparatus through reciprocating and multiplicative message distribution

(75) Inventors: Charles C. Hemesath, Hinckley, IL (US); Lawrence W. Becker, Aurora, IL (US); Jerry N. Fowler, Joliet, IL (US); Gerry A. Graesser, Addison, IL (US); Michael C. Lai, Lisle, IL (US)

Correspondence Address: PATTON BOGGS, 1660 LINCOLN ST, SUITE 2050, DENVER, CO, 80264, US

(73) Assignee: Lucent Technologies Inc., Murray Hill, NJ (US)

(21) Appl. No.: 11/052,358

(22) Filed: Feb. 7, 2005

(51) Int. Cl. H04J 3/14; H04J 1/16; H04L 1/00; H04L 12/26; H04L 12/28; H04L 12/56

(52) U.S. Cl. 370/241

(57) ABSTRACT

In order to generate high bandwidth traffic in a digital communication network that uses direct addressing message distribution, the present message traffic generation system uses existing external signaling drivers to initiate stimulus message traffic over low speed links. In the present message traffic generation system, a low bandwidth message generator is used in combination with reciprocating message distribution methods to generate high bandwidth stimulus message traffic and thereby verify the high bandwidth utilization of the high bandwidth transport mediums and the switching system nodes they interconnect.

### FIELD OF THE INVENTION

This invention relates to digital communication networks and in particular to a system that provides high bandwidth message traffic using low bandwidth stimulus messages.

### Problem

It is a problem in digital communication networks to efficiently verify the full bandwidth utilization of the switching system nodes over the high bandwidth signaling links that interconnect the various switching system nodes of the digital communication network. In order to accomplish the testing required, a large number of expensive signaling emulators are required. The signaling emulators generate traffic that is used to exercise the digital communication network. The operation of the digital communication network in response to these inputs is then measured to determine whether there are bandwidth utilization problems in the digital communication network. However, the cost of these emulators is significant and the bandwidth capacity of the digital communication network and especially the signaling links that interconnect switching system nodes increases with improvements in technology, thereby necessitating the replacement of these emulators with ones of higher capacity, and the costs associated therewith.

It is therefore a continuing problem to create the traffic required to provide the high bandwidth message traffic to exercise the digital communication network.

### Solution

The above described problems are solved and a technical advance achieved by the present system for bandwidth testing digital communication networks using reciprocating messages (termed “message traffic generation system” herein). In order to generate high bandwidth traffic in a digital communication network that uses direct addressing message distribution, the present message traffic generation system uses existing external low bandwidth signaling drivers to initiate stimulus message traffic over low speed links.

Direct addressing comprises the ability of a signaling protocol to use an originating address and a destination address to enable a message to traverse the digital communication network. Typical digital communication networks that use direct addressing include packet switched networks. Digital communication networks use high bandwidth message transport mediums to interconnect the switching system nodes that constitute the network. The high bandwidth message transport mediums presently range in size from 64 Kbs bandwidth to beyond the 155 Mbps bandwidth of the OC-3 protocol and increase with improvements in data transmission technology. In the present message traffic generation system, a low bandwidth message generator (termed “message driver” herein) is used in combination with reciprocating message distribution methods to generate high bandwidth stimulus message traffic and thereby verify the high bandwidth utilization of the high bandwidth transport mediums and the switching system nodes they interconnect. The message driver is connected via signaling links to at least one node in the digital communication network to propagate stimulus messages through the network.

The present message traffic generation system implements a plurality of reciprocating message distribution methods, including:

Bounce Mode—a node receives a message that contains specified parameters which cause the node to bounce the received message n times toward a single destination node or a list of nodes.

Echo Mode—a node receives a “bounce” message and returns the received message to the originating node with minimal manipulation of the content of the received message.

Burst Mode—a node can initiate a burst of traffic toward a single specified node or n nodes in the node address list, including the ability to burst traffic while traversing the node address list.

These reciprocating message distribution methods can be used singularly or in various combinations and modifications to thereby generate a significant stimulus traffic load to enable the testing of the switching system nodes and the high bandwidth signaling links that interconnect the various switching system nodes of the digital communication network.

### BRIEF DESCRIPTION OF THE DRAWINGS

FIG. 1 illustrates in block diagram form a combination of various operational scenarios of the present message traffic generation system for the exchange of stimulus messages among the various nodes in the digital communication network using reciprocating message distribution methods;

FIGS. 2A & 2B illustrate in the operation of the message traffic generation system using a single node address rather than a node address list in the stimulus message;

FIGS. 3A & 3B illustrate in the operation of the message traffic generation system a Node Address List in the stimulus message;

FIGS. 4A & 4B illustrate in the operation of the message traffic generation system using a Node Address List in the stimulus message as well as multiple Bounce Nodes;

FIGS. 5A & 5B illustrate in the operation of the message traffic generation system using a Node Address List in the stimulus message in a burst mode; and

FIGS. 6A & 6B illustrate in the operation of the message traffic generation system using a single Node Address in the stimulus message in a burst mode.

### DETAILED DESCRIPTION

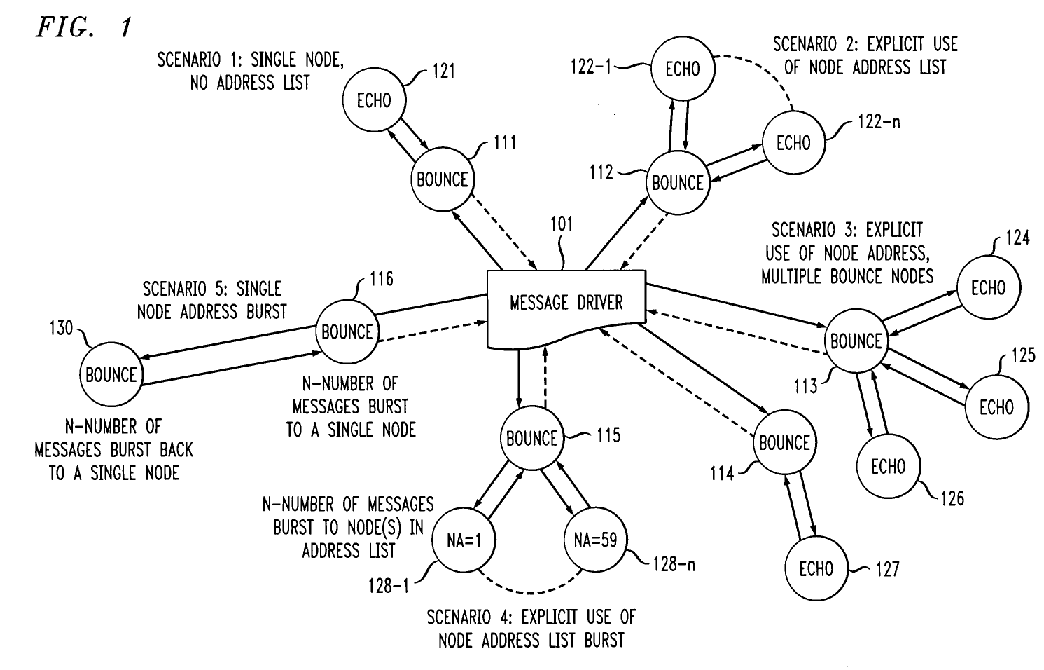

FIG. 1 illustrates in block diagram form a combination of various operational scenarios of the present message traffic generation system for the exchange of stimulus messages among the various nodes in the digital communication network using reciprocating message distribution methods. In particular, in each of the five operational scenarios illustrated in FIG. 1, the Message Driver 101 is connected to at least one switching system node (termed “nodes” herein) 111-116 of the digital communication network. Each of these nodes 111-116 are in turn connected to one or more nodes 121-130 of the digital communication network. The grouping of these nodes in FIG. 1 reflects five different stimulus message propagation scenarios, as noted on FIG. 1. These include: Single Node, No Node Address List; Explicit Use of Node Address List; Explicit Use of Node Address List, Multiple Bounce Nodes; Explicit Use of Node Address List—Burst Mode; and Single Node Address—Burst Mode. Variations or combinations of these stimulus message propagation scenarios are possible, and these scenarios are described below to illustrate the concept of the invention. In this environment, the present message traffic generation system comprises the Message Driver 101 and the reciprocating message distribution methods that are implemented by Bounce and Echo Nodes in the digital communication network.

Single Node Address—No Node Address List

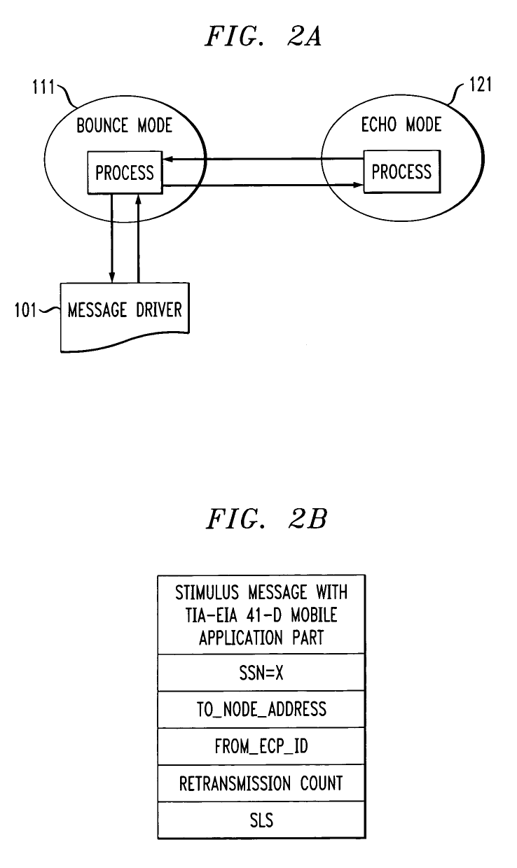

FIG. 2A illustrates in block diagram form the operation of the present message traffic generation system using a single node address reciprocating message distribution method rather than a node address list in the stimulus message. The Message Driver 101 is connected to and in communication with one of the nodes 111 (originating node) of the digital communication network, such as Executive Cellular Processor (ECP), in order to generate the stimulus message traffic. The implementation of this mode of reciprocating message distribution on the Executive Cellular Processor typically uses the TO_Node_Address and FROM_Node_Address fields in a stimulus message to identify the destination node. The signaling message protocol can be the TIA-EIA 41-D Mobile Application Part protocol as shown in FIG. 2B. The above-noted fields in this message protocol can index a Node Address List that is part of the network defined Node Addresses maintained by the originating node 111 and this address is used by the other nodes in the digital communication network to route the stimulus message through the network to the identified destination node. Alternatively, the Message Driver 101 can include specific originating and terminating Node Addresses in the Node Address List on the stimulus message and set an indicator in the stimulus message to determine whether single node or multiple node transmission is desired. The maximum retransmission count available in the existing indicator field is 255−1 (one message is used to provide a response to the initiating message driver), so 254 messages can be sent to a single destination node 121 for each stimulus message that is originated by the Message Driver 101. This reciprocating message distribution method only allows the originating node 111 to transmit the stimulus message to a single specified destination node 121 since it is desired to maintain a short message length.

As shown in FIG. 2A, the Message Driver 101 creates a stimulus message of the form and content noted above and transmits this stimulus message to the Originating Node 111 which operates in the Bounce Mode. The Originating Node 111 looks at both the Node Address List and the retransmission count fields contained in the stimulus message, then decrements the retransmission count and transmits the entire stimulus message to the first Node identified by the Node Address retrieved from the Node Address List. The Originating Node 111 waits for the return of the stimulus message from the Destination Node 121, which operates in the Echo Mode, then repeats this operation if the retransmission count is greater than 0. The failure of the stimulus message to return from the Destination Node 121 within a predetermined time results in the process timing out and automatically advancing to the next retransmission count.

Explicit Use of Node Address List in Stimulus Message

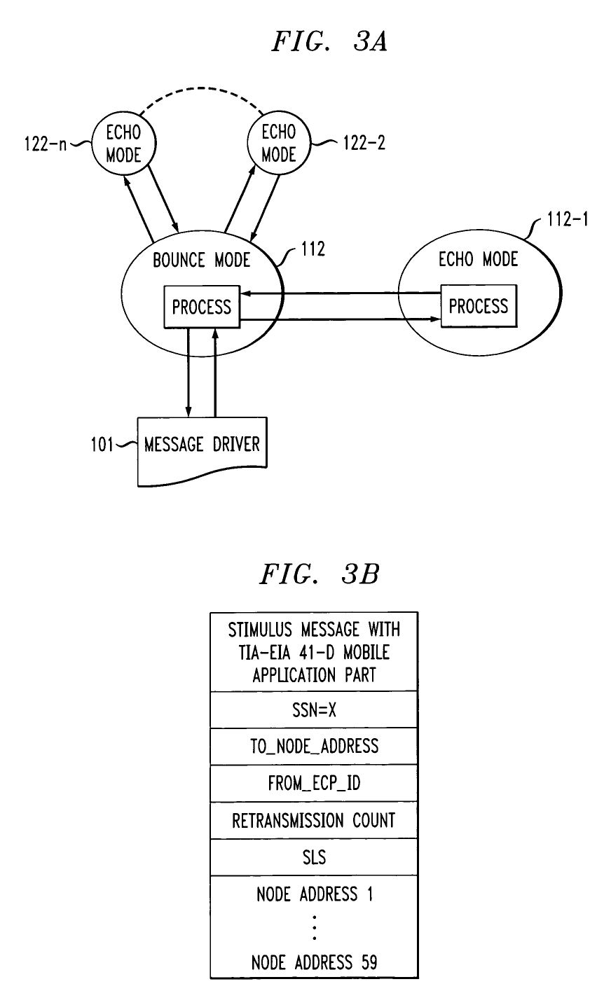

FIG. 3A illustrates in block diagram form the operation of the present message traffic generation system using a Node Address List in the Stimulus Message. The Message Driver 101 is connected to and in communication with one of the nodes 112 (originating node) of the digital communication network, such as Executive Cellular Processor (ECP), in order to generate the stimulus message traffic. The implementation of this mode of reciprocating message distribution on the Executive Cellular Processor typically uses the TO_Node_Address and FROM_Node_Address fields in a stimulus message to identify the destination nodes. The signaling message protocol can be the TIA-EIA 41-D Mobile Application Part protocol as shown in FIG. 3B. The above-noted fields in this message protocol can index a Node Address List that is part of the network defined Node Addresses maintained by the Originating Node 112 and this address is used by the other nodes in the digital communication network to route the stimulus message through the network to the identified destination nodes, such as 122-1 to 122-n or directly use the node addresses contained in the node address list of the stimulus message. A typical UnitData (UDT) message can accommodate 58 (59−1) Node Addresses in a Node Address List that is contained in the stimulus message while a typical extended UnitData (XUDT) message can accommodate 254 (255−1) Node Addresses in a Node Address List that is contained in the stimulus message. The traffic pattern generated by the Node Address List can include a mix of Node Addresses that are the same or unique. In this case, the node address list is traversed n number of times based on the retransmission count. That is based on the fact that n nodes are sent messages up to 59−1 or 255−1 times. The multiplying is via the fact that each stimulus message generates n number of messages based on what is in the node address list. Retransmission in this case only serves as a count of how many to look at in this case, not a multiplier. It is a multiplier in single node cases. In each of these cases, the first Node Address in the Node Address List (the −1 element noted above) is reserved for keeping track of the originating node for the final acknowledgement.

As shown in FIG. 3A, the Message Driver 101 creates a stimulus message of the form and content noted above and transmits this stimulus message to the Originating Node 112 which operates in the Bounce Mode. The Originating Node 112 looks at both the Node Address List and the retransmission count fields contained in the stimulus message then decrements the retransmission count and transmits the entire stimulus message to the first Node Address retrieved from the Node Address List. The Originating Node 112 waits for the return of the stimulus message from the Destination Node 122-1, then repeats the operation for the next Node Address contained in the Node Address List of the stimulus message. The failure of the stimulus message to return from the Destination Node 122-1 within a predetermined time results in the process timing out and automatically advancing to the next retransmission count. Once the entirety of the Node Address List is traversed, the Originating Node 112 again decrements the retransmission count if it is not zero and repeats the stimulus message transmission process.

Explicit Use of Node Address List in Stimulus Message—Multiple Bounce Nodes

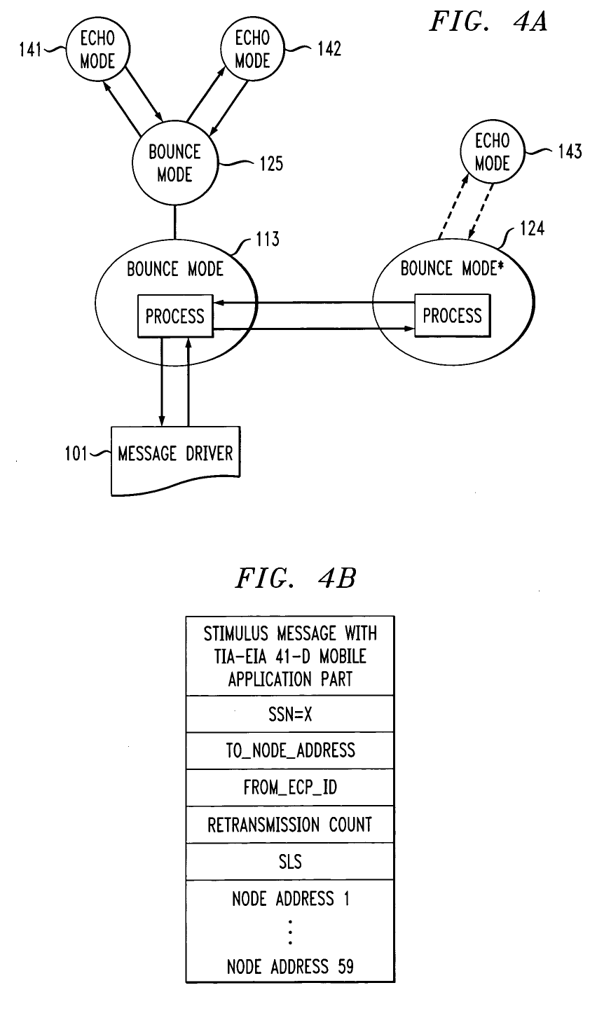

FIG. 4A illustrates in block diagram form the operation of the present message traffic generation system using a Node Address List in the stimulus message as well as multiple Bounce Nodes. The node configuration of FIG. 4A is somewhat different from that shown for this scenario in FIG. 1, though both portray the concept of multiple bounce nodes. The Message Driver 101 is connected to and in communication with one of the nodes 113 (originating node) of the digital communication network, such as Executive Cellular Processor (ECP), in order to generate the stimulus message traffic. The implementation of this mode of reciprocating message distribution on the Executive Cellular Processor typically uses the TO_Node_Address and FROM_Node_Address fields in a stimulus message to identify the destination nodes. The signaling message protocol can be the TIA-EIA 41-D Mobile Application Part protocol as shown in FIG. 4B. The above-noted fields in this message protocol can index a Node Address List that is part of the network defined Node Addresses maintained by the Originating Node 113 and this address is used by the nodes in the digital communication network to route the stimulus message through the network to the identified destination nodes or directly use the node addresses contained in the node address list of the stimulus message. A typical UnitData (UDT) message can accommodate 58 (59−1) Node Addresses in a Node Address List that is contained in the stimulus message while a typical extended UnitData (XUDT) message can accommodate 254 (255−1) Node Addresses in a Node Address List that is contained in the stimulus message. The traffic pattern generated by the Node Address List can include a mix of Node Addresses that are the same or unique. In this case, the node address list is traversed n number of times based on the retransmission count. That is based on the fact that n nodes are sent messages up to 59−1 or 255−1 times. The multiplying is via the fact that each stimulus message generates n number of messages based on what is in the node address list. Retransmission in this case only serves as a count of how many to look at in this case, not a multiplier. It is a multiplier in single node cases. In each of these cases, the first Node Address in the Node Address List (the −1 element noted above) is reserved for keeping track of the originating node for the final acknowledgement.

In addition, the stimulus message can also include an indicator that each Node that receives the stimulus message should also bounce the stimulus message to the Nodes contained in the Node Address List. Thus, multiple nodes drive traffic across the entire digital network by the single stimulus message initiating multiple Bounce Nodes. Thus, as shown in simplified form in FIG. 4A, Originating Node 113 forwards the received stimulus message to Bounce Nodes 124, 125 which themselves forward the received stimulus message traffic to Destination Nodes 141-143 where the stimulus messages are echoed back to the Originating Node 113 via the intervening Bounce Nodes 113, 124, 125.

As shown in FIG. 4A, the Message Driver 101 creates a stimulus message of the form and content noted above and transmits this stimulus message to the Originating Node 113, which operates in the Bounce Mode. The Originating Node 113 looks at both the Node Address List and the retransmission count fields contained in the stimulus message then decrements the retransmission count and transmits the entire stimulus message to the first Node Address retrieved from the Node Address List, such as Node 124. Bounce Node 124 operates in the Bounce Mode, as instructed by the information contained in the stimulus message, and forwards the received stimulus message to the identified Destination Node, such as node 143. The Originating Node 113 waits for the return of the stimulus message from the Destination Node 143, as routed through intervening nodes 124, 113, then repeats the operation for the next Node Address contained in the Node Address List of the stimulus message. The failure of the stimulus message to return from the Destination Node 143 within a predetermined time results in the process timing out and automatically advancing to the next retransmission count. Once the entirety of the Node Address List is traversed, the Originating Node 113 again decrements the retransmission count if it is not zero and repeats the stimulus message transmission process.

This process is repeated at each node contained in the Node Address List, as they each become a stimulus message originating Node 113.

Explicit Use of Node Address List in Stimulus Message—Burst Mode

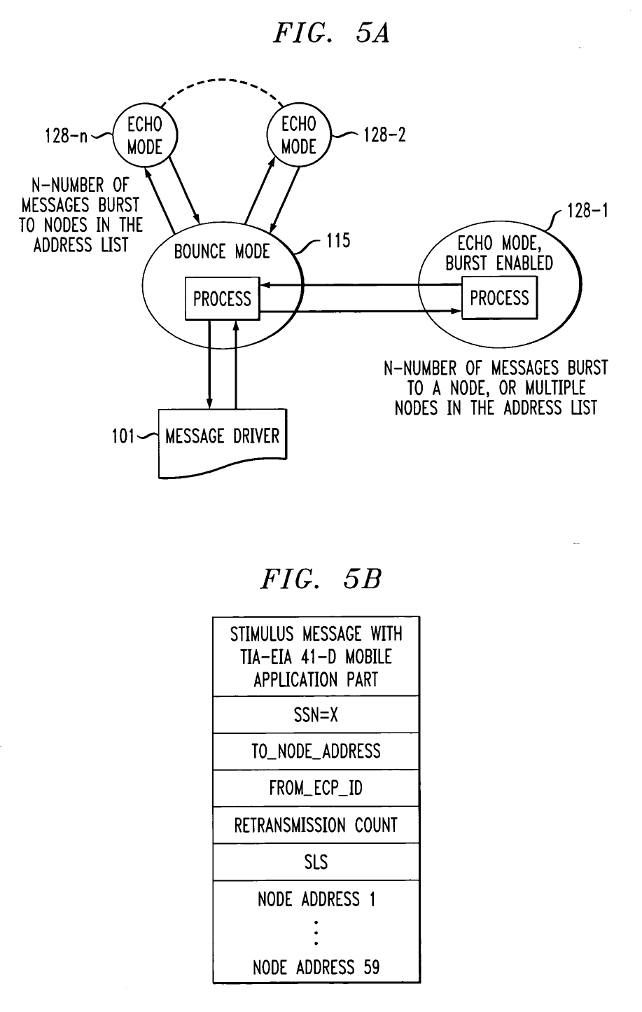

FIG. 5A illustrates in block diagram form the operation of the present message traffic generation system using a Node Address List in the stimulus message in a burst mode. The Message Driver 101 is connected to and in communication with one of the nodes 115 (originating node) of the digital communication network, such as an Executive Cellular Processor (ECP), in order to generate the stimulus message. The implementation of this mode on the Executive Cellular Processor typically uses the TO_Node_Address and FROM_Node_Address fields in a stimulus message to identify the destination node. The signaling message protocol can be the TIA-EIA 41-D Mobile Application Part protocol as shown in FIG. 5B. The above-noted fields in this message protocol can index a Node Address list that is part of the network defined Node Addresses maintained by the Originating Node 115 and this address is used by the nodes in the digital communication network to route the stimulus message through the network to the identified destination nodes or directly use the node addresses contained in the node address list of the stimulus message. A typical UnitData (UDT) message can accommodate 58 (59−1) Node Addresses in a Node Address List that is contained in the stimulus message while a typical extended UnitData (XUDT) message can accommodate 254 (255−1) Node Addresses in a Node Address List that is contained in the stimulus message. The traffic pattern generated by the Node Address List can include a mix of Node Addresses that are the same or unique. In this case, the node address list is traversed n number of times based on the retransmission count. That is based on the fact that n nodes are sent messages up to 59−1 or 255−1 times. The multiplying is via the fact that each stimulus message generates n number of messages based on what is in the node address list. Retransmission in this case only serves as a count of how many to look at in this case, not a multiplier. It is a multiplier in single node cases. In each of these cases, the first Node Address in the Node Address List (the −1 element noted above) is reserved for keeping track of the originating node for the final acknowledgement. In addition, the stimulus message can include a burst indicator that the Destination Nodes 128-1 to 128-n that receive the stimulus message should burst the stimulus message n times to either the Originating Node 115 or to one or more of the Nodes contained in the Node Address List. Thus, multiple nodes drive asynchronous traffic across the entire digital network by the single stimulus message which operates to initiate multiple burst enabled Echo Nodes to generate asynchronous burst stimulus message traffic.

As shown in FIG. 5A, the Message Driver 101 creates a stimulus message of the form and content noted above and transmits this stimulus message to the Originating Node 115. The purpose of the burst is to generate asynchronous traffic patterns which mimic real world applications, such as data transmission/setup. The Originating Node 115 looks at both the Node Address List and the retransmission count fields contained in the stimulus message then decrements the retransmission count and transmits the entire stimulus message to the first Node Address retrieved from the Node Address List. The Originating Node 115 waits for the return of the stimulus message from the Destination Node 128-1, then repeats the operation for the next Node Address contained in the Node Address List of the stimulus message. The failure of the stimulus message to return from the Destination Node 128-1 within a predetermined time results in the process timing out and automatically advancing to the next retransmission count. Once the entirety of the Node Address List is traversed, the Originating Node 115 again decrements the retransmission count if it is not zero and repeats the stimulus message transmission process.

This process is supplemented by each Destination Node 128-1 to 128-n contained in the Node Address List, retransmitting the received stimulus message n times to either the Originating Node 115 or one or more of the Nodes contained in the Node Address List, as each Destination Node 115 become a stimulus message Originating Node. While the Destination Nodes are shown in this example as the burst generation elements in the digital communication network, intervening nodes in the network can be activated to generate the bursts of stimulus message traffic in addition to or in place of the Destination Nodes. In addition, the Originating Node 115 does not have to be the target of the burst traffic, since the stimulus message can be programmed to activate multiple nodes in the digital communication network to generate bursts of stimulus message traffic targeted to an identified target node(s).

Single Node Address—Burst Mode

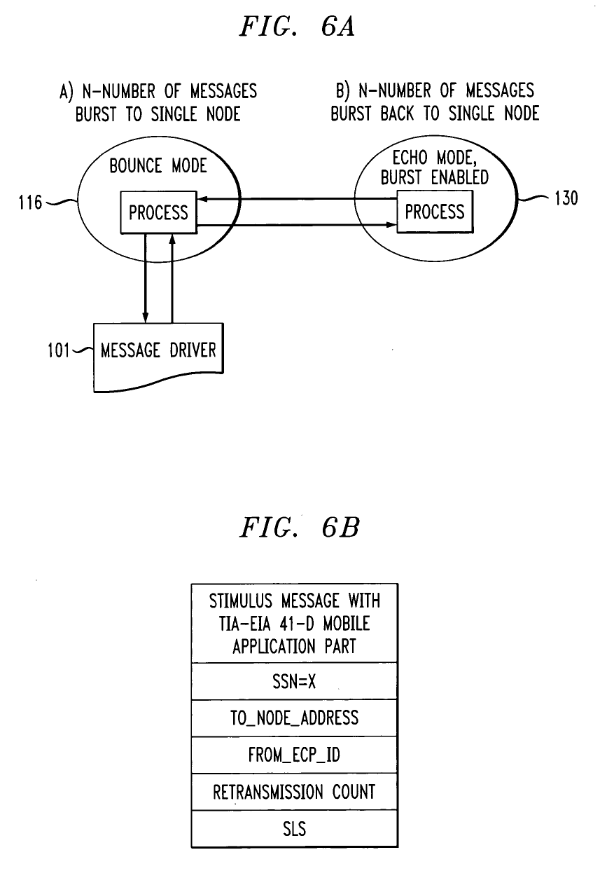

FIG. 6A illustrates in block diagram form the operation of the present message traffic generation system using a single Node Address in the stimulus message in a burst mode. The Message Driver 101 is connected to and in communication with one of the nodes 116 (originating node) of the digital communication network, such as Executive Cellular Processor (ECP) in order to generate the stimulus message. The implementation of this mode of reciprocating message distribution on the Executive Cellular Processor typically uses the TO_Node_Address and FROM_Node_Address fields in a stimulus message to identify the destination node. The signaling message protocol can be the TIA-EIA 41-D Mobile Application Part protocol as shown in FIG. 6B. The above-noted fields in this message protocol can index a Node Address List that is part of the network defined Node Addresses maintained by the Originating Node 116 and this address is used by the nodes in the digital communication network to route the stimulus message through the network to the identified Destination Node 130. Alternatively, the Message Driver 101 can include specific originating and terminating Node Addresses in the Node Address list on the message and set an indicator in the message to determine whether a single node or multiple node transmission is desired. The maximum retransmission count available in the existing indicator field is 255−1, so 254 messages can be sent to a single destination node for each stimulus message that is originated by the Message Driver 101. This method only allows the Originating Node 116 to transmit the stimulus message to a single specified Destination Node 130 since it is desired to maintain a short message length. The single Destination Node 130 then generates a burst of stimulus message traffic in response to receipt of the stimulus message from the Originating Node 116.

As shown in FIG. 6A, the Message Driver 101 creates a stimulus message of the form and content noted above and transmits this stimulus message to the Originating Node 116, which operates in the Bounce Mode. The Originating Node 116 looks at both the Node Address List and the retransmission count fields contained in the stimulus message then decrements the retransmission count and transmits the stimulus message to the single Node Address retrieved from the Node Address List. The Originating Node 116 waits for the return of the stimulus message traffic from the Destination Node 130, then repeats the operation if the retransmission count is greater than 0. The failure of the stimulus message to return from the Destination Node 130 within a predetermined time results in the process timing out and automatically advancing to the next retransmission count.

This process is supplemented by the single Destination Node 130 contained in the Node Address List, retransmitting the received stimulus message in a burst n times to the Originating Node 116 or a Node that the burst refers to, not necessarily the Originating Node, as the Destination Node 130 become a stimulus message Originating Node for a burst of traffic. Likewise, the Originating Node 116 can generate a burst of stimulus message traffic to the Destination Node 130.

### SUMMARY

The message traffic generation system uses a low bandwidth message generator in combination with reciprocating message distribution methods to generate high bandwidth stimulus message traffic and thereby verify the high bandwidth utilization of the high bandwidth transport mediums and the switching system nodes they interconnect. The propagation of stimulus messages by the Message Driver throughout the digital communication network activates various nodes within the network to themselves generate stimulus message traffic, thereby creating a high bandwidth traffic load by the multiplication of the stimulus messages in a controlled manner to exercise and test the various nodes and interconnecting links.

What is claimed:

1. A message traffic generation system, operable in a digital communication network that comprises a plurality of nodes, interconnected by high bandwidth signaling links, for propagating stimulus messages throughout said digital communication network, comprising:
message driver means for transmitting at least one stimulus message to at least one originating node of said plurality of nodes via associated signaling links;
message propagation means, located in said at least one originating node and responsive to the receipt of said stimulus message, for transmitting said stimulus message to at least one destination one of said plurality of nodes via associated signaling links; and
message echo means, located in said at least one destination node and responsive to receipt of said stimulus message, for returning said stimulus message to said at least one originating node.

2. The message traffic generation system of claim 1 wherein said message driver means comprises:
node address means for identifying a single node address in said stimulus message as said destination node.

3. The message traffic generation system of claim 2 wherein said message propagation means comprises:
retransmission means for transmitting said stimulus message a predetermined plurality of times to said destination node via associated signaling links.

4. The message traffic generation system of claim 1 wherein said message driver means comprises:
node address means for identifying a node address list in said stimulus message that identifies said destination nodes.

5. The message traffic generation system of claim 4 wherein said message propagation means comprises:
retransmission means for transmitting said stimulus message a predetermined plurality of times to at least one destination one of said plurality of nodes via associated signaling links.

6. The message traffic generation system of claim 1 wherein said message echo means comprises:
burst means, responsive to receipt of said stimulus message, for generating a burst of said stimulus messages for return said at least one originating node.

7. The message traffic generation system of claim 1 wherein said message echo means comprises:
burst means, responsive to receipt of said stimulus message, for generating a burst of said stimulus messages for return at least one identified node.

8. The message traffic generation system of claim 1 further comprising:
bounce node means, responsive to receipt of said stimulus message, for forwarding said received stimulus message to at least one other one of said plurality of nodes via associated signaling links.

9. The message traffic generation system of claim 8 wherein said bounce node means comprises:
retransmission means for transmitting said stimulus message a predetermined plurality of times to at least one destination one of said plurality of nodes via associated signaling links.

10. The message traffic generation system of claim 8 wherein said bounce node means comprises:
burst means, responsive to receipt of said stimulus message, for generating a burst of said stimulus messages for return at least one identified node.

11. A method of operating a message traffic generation system, operable in a digital communication network that comprises a plurality of nodes, interconnected by high bandwidth signaling links, for propagating stimulus messages throughout said digital communication network, comprising:
transmitting at least one stimulus message to at least one originating node of said plurality of nodes via associated signaling links;
forwarding, from said at least one originating node in response to the receipt of said stimulus message, said stimulus message to at least one destination one of said plurality of nodes via associated signaling links; and
returning, from said at least one destination node in response to receipt of said stimulus message, said stimulus message to said at least one originating node.

12. The method of operating a message traffic generation system of claim 11 wherein said step of transmitting comprises:
identifying a single node address in said stimulus message as said destination node.

13. The method of operating a message traffic generation system of claim 12 wherein said step of forwarding comprises:
retransmitting said stimulus message a predetermined plurality of times to said destination node via associated signaling links.

14. The method of operating a message traffic generation system of claim 11 wherein said step of transmitting comprises:
node address means for identifying a node address list in said stimulus message that identifies said destination nodes.

15. The method of operating a message traffic generation system of claim 14 wherein said step of forwarding comprises:
retransmitting said stimulus message a predetermined plurality of times to at least one destination one of said plurality of nodes via associated signaling links.

16. The method of operating a message traffic generation system of claim 11 wherein said step of returning comprises:
generating, in response to receipt of said stimulus message, a burst of said stimulus messages for return said at least one originating node.

17. The method of operating a message traffic generation system of claim 11 wherein said step of returning comprises:
generating, in response to receipt of said stimulus message, a burst of said stimulus messages for return at least one identified node.

18. The method of operating a message traffic generation system of claim 11 further comprising:
forwarding, in response to receipt of said stimulus message, said received stimulus message to at least one other one of said plurality of nodes via associated signaling links.

19. The method of operating a message traffic generation system of claim 18 wherein said step of returning comprises:
retransmitting said stimulus message a predetermined plurality of times to at least one destination one of said plurality of nodes via associated signaling links.

20. The method of operating a message traffic generation system of claim 18 wherein said step of returning comprises:
generating, in response to receipt of said stimulus message, a burst of said stimulus messages for return at least one identified node.
